(19) United States
(12) Patent Application Publication
(10) Pub. No.: US 2006/0278126 A1
(43) Pub. Date: Dec. 14, 2006

(54) PIGMENT AGGLOMERATES, THEIR MANUFACTURE, AND USE

(76) Inventor: Terrance Fenelon, Mendota Heights, MN (US)

Correspondence Address: MERCHANT & GOULD PC, P.O. BOX 2903, MINNEAPOLIS, MN, 55402-0903, US

(21) Appl. No.: 11/426,702

(22) Filed: Jun. 27, 2006

Related U.S. Application Data
(63) Continuation-in-part of application No. 10/539,474.
(60) Provisional application No. 60/436,795, filed on Dec. 26, 2002.

(51) Int. Cl. C04B 14/00; C09C 1/22; C04B 14/04

(52) U.S. Cl. 106/459; 106/482; 106/401

(57) ABSTRACT

A pigment agglomerate and method of making the pigment agglomerate. The agglomerate is a collection of pigment particles and at least one carrier particle, the pigment particles and carrier particle held together by interparticle forces such as magnetic forces, electrostatic forces, van der Waal's forces, and other physical or chemical interparticle forces. A chemical surface treatment or other treatment may be applied to either or both of carrier particles and pigment particles in order to improve the interparticle forces therebetween. No binder, such as a polymeric binder or adhesive, is used to adhere or maintain the particles together forming the agglomerates.

This application is a continuation-in-part of Ser. No. 10/539,474, filed Jun. 20, 2005, which is a national stage filing of PCT/US2003/041469 filed Dec. 22, 2003, which claims priority under 35 U.S.C. § 119(e) to U.S. provisional application Ser. No. 60/436,795, filed Dec. 26, 2002 and entitled “Pigment Agglomerates, Their Manufacture, and Their Use”. The entire disclosure of these applications is incorporated herein by reference.

The present invention is directed to pigment agglomerates for use in coloring concrete and other cementitous products, and methods for making the pigment particles.

### BACKGROUND OF THE INVENTION

Common, gray concrete is used extensively throughout the construction and building industries and is generally the norm. However, many industries which utilize concrete and other cementitious products such as mortars and grouts are adding a coloring agent, such as a pigment, to the concrete or cementitous product. For ease of description herein, such cementitious products will be referred to simply as concrete or concrete products, it being understood that such simple terminology is intended to refer to the broader category of cementitious products. The pigment can be either mixed into the wet concrete prior to pouring or can be topically applied to the concrete after pouring.

Iron oxide, which is available in various colors as a powder, is one common pigment for use with concrete. In order to provide a wide range of colors, a supplier will custom mix multiple base colors of pigment to obtain the desired final shade. One common problem with iron oxide, and other pigments, is that the pigment powder is difficult to handle. The powders have a tendency to clump, which causes irregular flow during conveyance (such as transporting with an auger, dumping, etc.) and which can clog machinery and transport lines or tubes.

There are many commercially available pigment products that have attempted to address the problems of clumping. For example, HG Starck, a division of Bayer Company, produces a compressed powered pigment. Davis Colors has a competing pigment line, which uses pigment granules of iron oxide color particles that are combined with a binder material. These pigment granules are not compacted or briquetted granules. See U.S. Pat. No. 4,946,505 (Jungk).

What is desired is an improved coloring product for use in concrete.

### SUMMARY OF THE INVENTION

The invention is directed to a method of making particulate pigment for use in coloring concrete products. The particulate pigment product is an agglomerate of pigment particles and at least one carrier particle. The carrier particle acts as a nucleus for the agglomerate.

In one aspect of the invention, a pigment agglomerate consisting of at least one carrier particle and a plurality of pigment particles is provided. In a preferred aspect, the carrier particle is a silica particle, such as silica fume. In another preferred aspect, either additionally or alternately to the former preferred aspect, the pigment particles are iron oxide particles. In one aspect, the pigment agglomerate consists essentially of a weight ratio of about 0.5:100 to 3:10 carrier particles:pigment particles. In another aspect, the pigment agglomerate consists essentially of 0.5 wt-% to 5 wt-% carrier particles and the remainder pigment particles. In another aspect, the pigment agglomerate consists essentially of 1 wt-% to 2 wt-% carrier particles and the remainder pigment particles.

The invention is also directed to methods of making pigment agglomerates. The method mixes together carrier particles and pigment particles, preferably at a weight ratio of about 0.5:100 to 3:10 (carrier particles:pigment particles), the mixing being done in a tumbling or rotary motion. No polymeric binder or other binder material is needed to provide the pigment agglomerates. Rather, the carrier particles and pigment particles form generally spherical agglomerates that are held together by interparticle forces. By the term “interparticle forces”, what is intended is a force that originates in one particle and acts upon a force in another particle or upon the other particle itself. In a preferred method for making the pigment agglomerates, the carrier particles and pigment particles are mixed together at a weight ratio of about 0.5:100 to 5:100.

Pigment agglomerates according to the present invention have improved flowability over non-agglomerated pigments. For example, an agglomerate consisting of silica fume and iron oxide is easier to handle (e.g., pour, auger, transport) than iron oxide without the silica fume carrier.

When exposed to a concrete mix (i.e., the cement, sand, water, etc.), the pigment agglomerate is destroyed and the pigment particles disperse homogenously throughout the concrete. Additionally, the carrier particle may impart beneficial properties to the concrete.

### BRIEF DESCRIPTION OF THE DRAWINGS

FIG. 1 is a schematic perspective view of a pigment agglomerate according to the invention;

FIG. 2 is an enlarged, cross-sectional view of a first variation of the pigment agglomerate of FIG. 1; and

FIG. 3 is an enlarged, cross-sectional view of a second variation of the pigment agglomerate of FIG. 1.

### DETAILED DESCRIPTION

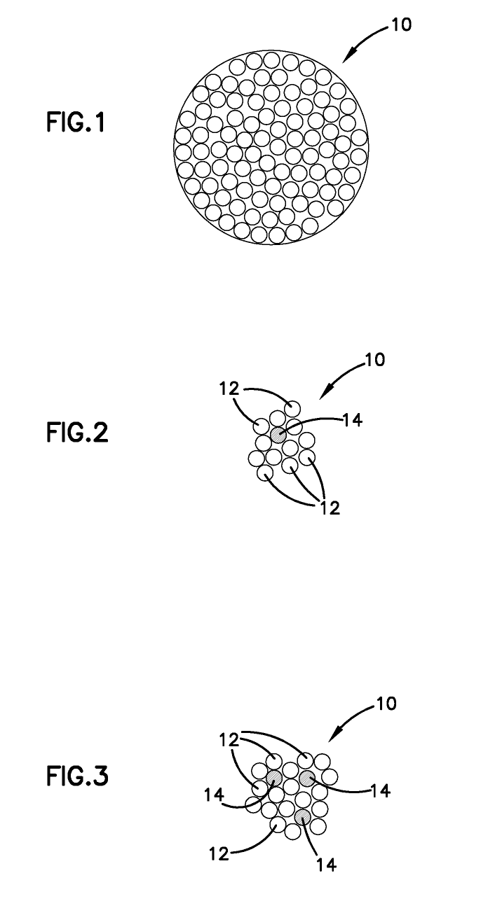

Referring to the figures, wherein like numerals represent like elements throughout the several views, there is schematically illustrated in FIGS. 1, 2 and 3 a pigment agglomerate 10. Pigment agglomerate 10 is formed by a plurality of pigment particles 12 and at least one carrier particle 14. Carrier particles 14 are illustrated in FIGS. 2 and 3 as being shaded. This shading is merely to facilitate understanding of the invention and to differentiate between pigment particles 12 and carrier particles 14, and is not intended to limit the coloring or such of carrier particles 14. As seen in FIGS. 2 and 3, carrier particle 14 is present within an interior of agglomerate 10 and is surrounded by, and typically covered by, pigment particles 12. In FIG. 2, agglomerate 10 has one carrier particle 14 and a plurality of pigment particles 12. In FIG. 3, agglomerate 10 has multiple carrier particles 14 and a plurality of, or multiple, pigment particles 12. In the illustrated agglomerates 10, carrier particles 14 are internal particles, that is, they are not present on the exterior surface of agglomerate 10. However, in some agglomerates 10, a carrier particle 14 may form a portion of an exterior surface of agglomerate 10, although typically, carrier particle 14 will be surrounded by pigment particles 12, as illustrated in FIGS. 2 and 3.

The weight ratio of carrier particles 14 to pigment particles 12, in pigment agglomerate 10, is at least 1 to 100, and preferably at least 2 to 100. The ratio is no greater than 50 to 100, and usually no greater than 40 to 100. The ratio of carrier particles 14 to pigment particles 12 is selected to obtain improved flowability and processability of pigment particles 12 while maintaining the coloring properties of pigment particles 12. For some pigments, if the ratio of carrier particles 14 to pigment particles 12 is too high, the color obtained in the resulting concrete is diluted or discolored, compared to when pigment particles 12 alone are used. One preferred ratio of carrier particles 14: pigment particles 12 is 1:9, which provides agglomerate 10 with 10% carrier particles 14. Another preferred ratio of carrier particles 14: pigment particles 12 is 1:49, which provides agglomerate 10 with 2% carrier particles 14. Another preferred agglomerate 10 has 1.5% carrier particles 14.

Agglomerates 10 are held together, that is, pigment particles 12 are held to carrier particles 14, by interparticle forces that occur between particles 12 and particles 14. No polymeric binder (also commonly referred to as an adhesive) or other such additive is used to bind pigment particles 12 to carrier particles 14. It is the properties of pigment particles 12 and carrier particles 14 that form and hold agglomerates 10.

Pigment particles 12 are bound to carrier particles 14 by interparticle forces such as magnetic forces, electrostatic forces, van der Waal's forces, and other physical or chemical interparticle forces. At the time of this filing, it is not understood what forces hold pigment particles 12 and carrier particle 14 together as agglomerate 10, however it is known that the two particles 12 and 14 do not chemically react with one another, and the resulting agglomerate 10 retains discrete pigment particles 12 and carrier particles 14. As one example, carrier particle 14 may have a naturally occurring positive charge, and when combined with pigment particles 12 having a negative charge, particles 14 and 12 have a tendency to be attracted to each other. As another example, static electric charges or forces may attract and hold together particles 12 and 14.

When agglomerate 10 is destroyed, for example, by crushing, excessive shaking or application of harsh forces, agglomerate 10 breaks down to pigment particles 12 and carrier particles 14. If one were to have the patience and time, one could separate pigment particles 12 from carrier particles 14.

The interparticle forces that hold agglomerate 10 together can be either a naturally occurring characteristic of pigment particle 12, carrier particle 14, or both, or, the interparticle forces may be the result of a treatment or the like applied to the particle(s).

The charge of a particle, either of pigment particles 12 or carrier particles 14, may be enhanced or altered by pre-treating the particles with a surfactant or other similar, non-polymeric additive. For example, a naturally occurring positive charge on carrier particle 14 can be enhanced by a cationic surfactant, and/or a naturally occurring negative charge on pigment particle 12 can be enhanced by an anionic surfactant. Examples of suitable surfactants include those available under the trade designation “Tween” from ICI Surfactants. Both anionic and cationic surfactants are available from Goldschmidt Chemical Company, and from Fiber-Shield Industries, Inc.

Other procedures of enhancing the charge differential of pigment particles 12 and carrier particles 14 could also be used, including methods as simple as applying a static or magnetic charge to the particles by electricity or magnets.

As stated above, it is not understood what forces hold pigment particles 12 and carrier particles 14 together. Other interparticle enhancing procedures could be used to enhance the interparticle forces, depending on what the interparticle forces holding agglomerate 10 together are.

Agglomerates 10 generally have a size at least about 0.1 mm in diameter and more usually at least about 0.5 mm in diameter. Often, the diameter is at least 1 mm. Agglomerates 10 generally have a size no more than about 5 mm in diameter and often no more than about 4 mm.

Pigment Particles

Pigment particles 12 that may be suitable in agglomerates 10 of the invention for coloring concrete, or that may be suitable for forming agglomerates 10 by the inventive method, include both inorganic and organic pigments that are in the form of a dry powder. Classes of inorganic pigments include metallic oxides (e.g., iron, titanium, zinc, cobalt, chromium), metal powers (e.g., gold, aluminum), earth colors (e.g., siennas, ochers, umbers), lead chromates, and carbon black. Classes of organic pigments include animal (e.g., rhodopsin, melanin), vegetable, (e.g., chlorophyll, xanthophylls, indigo, flavone, carotene).

Examples of pigment particles 12 particularly believed to be suitable for incorporation into pigment agglomerate 10 include iron oxide, titanium dioxide, and carbon black. The preferred pigment particulate is iron oxide.

Iron oxide is typically available in various shades, ranging from yellow to red to almost black. The shade of the iron oxide is due to various contaminants and other additives present in the sample. Black iron oxide may also be referred to as ferrosoferric oxide, ferroferric oxide, iron oxide (magnetic), or black rouge, or even magnetite. Black iron oxide may appear reddish or bluish-black. Brown iron oxide may also be referred to as iron subcarbonate, or iron carbonate, and is typically reddish-brown containing ferric carbonate with ferric hydroxide Fe(OH₃) and ferrous hydroxide Fe(OH₂) in varying quantities. Metallic brown iron oxide is a naturally occurring earth, principally ferric oxide. Red iron oxide may also be referred to as burnt sienna, Indian red, red oxide, iron oxide red, rouge, or Turkey red, and is composed mainly of ferric oxide (Fe₂O₃). Yellow iron oxide may also be referred to as iron oxide yellow, and is a hydrated ferric oxide, Fe₂O₃.H2O. Typically, multiple source shades are combined to produce the desired shade.

Carrier Particle

As provided above, pigment agglomerates 10 are composed of pigment particles 12 and at least one carrier particle 14. Examples of suitable carrier particles 14 include silicas and oxides. An example of a preferred carrier particle 14 is silica fume.

Silica fume is a by-product of producing silicon metal or ferrosilicon alloys. Silica fume is also collected during the production of other silicon alloys and other alloys such as ferrochromium, ferromanganese, ferromagnesium, and calcium silicon. Silica fume particles consist primarily of small particle size amorphous (non-crystalline) silicon dioxide (SiO₂). Because of its chemical and physical properties, silica fume can be a very reactive pozzolan or pozzolanic material and is known as a cement additive. Silica fume is able to increase the performance (e.g., compressive strength) of a cementitious compound due to its high silica content, small particle size, and high surface area.

Pozzolans, or pozzolanic materials generally, are well known natural and synthetic silica-based materials that have been known and used for many years. Pozzolan is at least 50% silica (SiO₂), and is typically at least about 70% silica. The ancient Romans used pozzolan in mortar and concrete. In such cementitious materials, the pozzolan SiO₂ reacts with the lime released by the hydration of the cement, to improve the strength or other properties of the concrete. Pozzolan is defined as a “siliceous or siliceous aluminous material which in itself possesses little or no cementitious value but will, in finely divided form and in the presence of moisture, chemically react with calcium hydroxide at ordinary temperatures to form compounds possessing cementitious properties.” (ASTM C-618).

Silica fume that is collected from waste gases without being treated is called “undensified silica fume”; this distinguishes it from other forms of silica fume that have been treated. Undensified silica fume generally has particles of approximately 0.1 mm. It has a specific weight of about 200 to 300 kg/m³. To facilitate handling of silica fume, the industry often produces condensed silica fume, which is the product of further treated undensified silica fume, in which the particles are condensed until small spheres with diameters of about 0.5 to 1 mm are formed. The bulk density of the condensed silica fume is then increased to about 600 kg/m³. Condensed silica fume particles are mainly vitreous, and have a specific gravity of about 2.20. Condensed silica fume is primarily grayish in color, with levels varying from almost white to brownish-gray.

White amorphous silica fume is one type of silica fume often used as a cementitious additive. One white amorphous silica fume, commercially available from N or Chem, generally is 81-89% silicon dioxide (silica, SiO₂), has a moisture content of about 0.10-0.50%, has a specific gravity of about 2.20-2.70, a bulk density of about 38-44 lbs/ft³, and has an average particle size of about 0.9 micrometers and a surface area of about 10 m²/g. Another white silica fume, available from N or Chem, is about 85-93% amorphous silicon dioxide (silica), 6-13% zirconium dioxide (zirconia, ZrO₂), 0.5-2% aluminum oxide (alumina, Al₂O₃), and 0-6% calcium oxide (calcia, CaO).

In some embodiments, it may be desired to combine the silica fume with another carrier particle, typically another silica. Examples of other suitable silicas include silicon oxide, silicon dioxide, aluminum silicate, and calcium silicate. Available silicon dioxides include precipitated silica dioxide. The silica may be spherical in shape, blocky, or have an irregular shape. The silica may be naturally occurring or chemically prepared. The silica may be natural or may be treated, to provide, for example, a hydrophobic surface or an alkaline surface.

One precipitated silicon dioxide, commercially available from Degussa under the trade designation SIPERNAT 22, is a silica of spherical particles, low fines content and high oil absorption. It has a BET surface area of 190 m²/g, an average primary particles size of 18 nanometers and an average particle size of 7 micrometers, a compacted apparent density of 120 g/l and a density of 2 g/cm³, and a specific gravity of 2.

One specific example of a suitable agglomerate 10 includes 1-2 wt-% silica fume carrier particles 14 and 98-99 wt-% iron oxide pigment particles 12.

Another specific example of a suitable agglomerate 10 includes 0.5 wt-% silica fume carrier particles 14, 1 wt-% precipitated silica dioxide carrier particles 14, and 98.5 wt-% iron oxide pigment particles 12.

Manufacture of Pigment Agglomerates

The pigment agglomerates 10 of the invention are made by mixing together, with a rotary or rolling action, pigment particles 12 and carrier particles 14. Examples of equipment that provide suitable action for making agglomerates 10 include: a barrel mixer, a tumbler, a ribbon blender, a slow running vane extruder, and even a sealable jar or barrel that can be rolled about its longitudinal axis. An air mixer, which uses air flow to move the particles, may also be a suitable mixing technique. The motion desired for making of agglomerates 10 is a rolling action optionally combined with an easy falling action. Minimal shear forces on particles 12, 14 or agglomerates 10 are desired. The process of making agglomerate 10 can be compared to rolling a snowball, starting with a central core and having it build-up as it rolls. For agglomerates 10, carrier particle 14 is analogous to the central core and pigment particles 12 build-up around carrier particle 14 as the material is rolled.

A preferred method to make agglomerates 10 is to place 9 pounds of pigment particles 12 (preferably iron oxide pigment particles) into a hopper. Onto pigment particles 12 is placed 1 pound of carrier particles 14 (preferably silica fume particles). An auger at the base of the hopper feeds the particles along a path of about 4 feet into a first or upper end of a rotating tube having a length of about 20 feet and a diameter of about 18 inches. The tube is positioned with a downward tilt of about 3 degrees from horizontal. Positioned within the tube are screens, approximately 2 feet wide by 8 feet long and having approximately 1 inch square openings. The screens are folded to have approximately a right angle fold. The screens are free to rotate and fall around within the tube as it rotates.

The tube is rotated along its longitudinal axis at an rate of about 12 RPM, causing pigment particles 12 and carrier particles 14 to combine, tumble and agglomerate along the tube length from the first, upper, end to the second, lower, end of the tube. The screens help to break up any large clumps of pigment particles 12 and to scrape any material from off of the walls of the tube. The product obtained from the second end is the agglomerated pigment product.

In some embodiments, when making agglomerates 10, the weight ratio of carrier particles 14 to pigment particles 12 is at least 0.5 to 100, and preferably at least 1 to 100. As the amount of carrier particles 14 reduces, it becomes more difficult to form and retain agglomerates 10. The ratio of carrier particles 14 to pigment particles 12 is no greater than 50 to 100, and preferably no greater than 30 to 100.

In other embodiments, when making agglomerates 10, the percentage of carrier particles 14 in agglomerate 10 is at least 0.5%, and preferably at least 1%. As the percentage of carrier particles 14 reduces, it becomes more difficult to form and retain agglomerates 10. The percentage of carrier particles 14 in agglomerate 10 is no greater than 50%, and usually no greater than 30%. In some embodiments, the percentage of carrier particles 14 in agglomerate 10 is no greater than 10% or even 5%.

It has been found that when using a higher level of carrier particles 14, the resulting agglomerates 10 are either (1) smaller in size (diameter) than if less carrier particles 14 were used, (2) are more difficult to destroy, for example, by imparting harsh shear forces on agglomerates 10, or (3) both.

Coloring of Concrete

The pigment agglomerates 10 of the invention facilitate the addition of pigment to concrete and other cementitious products. Pigment agglomerates 10 have improved flowability over non-agglomerated pigment particles 12. Pigment particles 12, alone, have a tendency to clump, which can clog machinery and transport lines or tubes; this is especially the case for iron oxide. Providing pigment particles 12 with carrier particle 14 modifies the flow characteristics as compared to pigment particles 12 alone.

For example, agglomerates consisting of silica fume and iron oxide are easier to handle (e.g., pour, auger, transport) than iron oxide without the silica fume carrier. It has been found that iron oxide/silica fume agglomerates do not clump and provide less processing problems than iron oxide particles.

Use of agglomerates 10, which includes carrier particle 14, instead of straight pigment particles 12, typically does not detrimentally affect the coloring or shade of the concrete product. It should be understood that some agglomerates 10 may change the coloring characteristics, for example, if white or near-white pigment particles 12 are combined with a dark carrier particle 14, the resulting agglomerates 10 may have a darker color and provide the concrete with a darker color than pigment particles 12 alone. It has been found that silica fume, when used as carrier particle 14, generally does not affect the concrete color. However, this may differ if a dark gray silica fume or a high level of silica fume is used in agglomerates 10.

When exposed to a concrete mix (i.e., the cement, sand, water, etc), it is believed that pigment agglomerate 10 is destroyed, and pigment particles 12 and carrier particles 14 individually disperse homogenously throughout the concrete. Depending on the type of carrier particle 14 used, carrier particle 14 may impart beneficial physical properties to the concrete. For example, silica fume, when used by itself as an additive in concrete, increases the compressive strength of the concrete.

The foregoing description addresses embodiments of the present invention encompassing the principles of the present invention. The embodiments may be changed, modified and/or implemented using various types of arrangements. Those skilled in the art will readily recognize various modifications and changes which may be made to the present invention without strictly following the exemplary embodiments and applications illustrated and described herein, and without departing from the scope of the present invention.

I claim:

1. A pigment agglomerate comprising:
(a) a plurality of pigment particles; and
(b) a plurality of carrier particles held to the pigment particles by interparticle forces, wherein a weight ratio of the carrier particles to the pigment particles is about 0.5:10 to 3:10.

2. The pigment agglomerate according to claim 1, wherein the pigment particles comprises iron oxide and the carrier particles comprise silica fume.

3. The pigment agglomerate of claim 1, wherein the interparticle forces is at least one of magnetic forces, electrostatic forces, and van der Waal's forces.

4. A pigment agglomerate consisting essentially of:
(a) a plurality of pigment particles; and
(b) a plurality of carrier particles.

5. The pigment agglomerate according to claim 4, wherein the pigment particles comprise iron oxide and the carrier particles comprise silica fume.

6. The pigment agglomerate according to claim 4, wherein the pigment particles comprise iron oxide and the carrier particles comprise precipitated silicon dioxide.

7. The pigment agglomerate according to claim 4, wherein the agglomerate is 1-5% carrier particles.

8. The pigment agglomerate according to claim 4, wherein the agglomerate is 1-2% carrier particles.

9. A pigment agglomerate consisting of:
(a) a plurality of pigment particles; and
(b) a plurality of carrier particles.

10. The pigment agglomerate according to claim 9, wherein the pigment particles comprise iron oxide and the carrier particles comprise silica fume.

11. The pigment agglomerate according to claim 9, wherein the pigment particles comprise iron oxide and the carrier particles comprise precipitated silicon dioxide.

12. The pigment agglomerate according to claim 9, wherein the agglomerate is 1-5% carrier particles.

13. The pigment agglomerate according to claim 9, wherein the agglomerate is 1-2% carrier particles.

14. A method of making a pigment agglomerate comprising:
(a) mixing a plurality of pigment particles with a plurality of carrier particles, at a weight ratio of 0.5:100 to 0.5:10 carrier particles to pigment particles, the mixing being done with a rolling motion.

15. The method of claim 14, wherein the mixing of a plurality of pigment particles with a plurality of carrier particles comprises:
(a) mixing a plurality of iron oxide particles with a plurality of silica fume particles.

16. The method of claim 14, wherein the mixing of a plurality of pigment particles with a plurality of carrier particles comprises:
(a) mixing a plurality of iron oxide particles with a plurality of precipitated silicon dioxide particles.

17. The method of claim 14, wherein the mixing of a plurality of pigment particles with a plurality of carrier particles with a rolling motion comprises:
(a) mixing of a plurality of pigment particles with a plurality of carrier particles with a rolling motion in a barrel mixer, a tumbler, or a ribbon mixer.

18. The method of claim 14, wherein the mixing of a plurality of pigment particles with a plurality of carrier particles with a rolling motion consists of:
(a) mixing of a plurality of pigment particles with a plurality of carrier particles with a rolling motion in a barrel mixer, a tumbler, or a ribbon mixer.

19. The method of claim 14, wherein the mixing of a plurality of pigment particles with a plurality of carrier particles with a rolling motion comprises:
(a) mixing of a plurality of pigment particles with a plurality of carrier particles with a rolling motion in a barrel spinning or tumbling about its longitudinal axis.

20. The method of claim 14, wherein the mixing of a plurality of pigment particles with a plurality of carrier particles with a rolling motion consists of:
(a) mixing of a plurality of pigment particles with a plurality of carrier particles with a rolling motion in a barrel spinning or tumbling about its longitudinal axis.
